(19) United States
(12) Patent Application Publication
(10) Pub. No.: US 2025/0335844 A1
(43) Pub. Date: Oct. 30, 2025

(54) SYSTEM AND METHOD FOR PREDICTING DEMAND AT AN AIRLINE LEVEL FOR PROCURING ACCURATE NUMBER AND TYPE OF VEHICLES

(71) Applicant: AIRLINES REPORTING CORPORATION, Arlington, VA (US)

(72) Inventors: Shitalkumar Sarangdharrao SABNE, Aldie, VA (US); Nicholas Alexander GARE, Brandon, FL (US)

(73) Assignee: AIRLINES REPORTING CORPORATION, Arlington, VA (US)

(21) Appl. No.: 18/649,048

(22) Filed: Apr. 29, 2024

(51) Int. Cl. G08G 5/00

(52) U.S. Cl. CPC G06Q 10/06315; G06Q 10/02

(57) ABSTRACT

A method and system for predicting demand at an airline level for a future flight path for procurement of an appropriate number and type of an aircraft including acquiring data, aggregating segments of location pairs, and building, via a computer model, various connections based on the aggregated segments of location pairs, in which each of the segments of location pairs is serviced by an aircraft of at least one of many airlines. For each of the segments of location pairs, generating a quality of service index (QSI) coefficient for each of the airlines, generating a circuitry curve based on a distance of a segment of a location pair, and determining flight share information at an airline level for a target segment of location pair based on a corresponding QSI coefficient and a corresponding circuitry curve.

### TECHNICAL FIELD

This disclosure generally relates to a data-driven system and method predicting fare market share per airline for future travel departures and providing sufficient number and/or size of vehicles to meet expected demand. More specifically, the disclosure is directed to reducing a number of oversold flights and to avoid preventable travel delays.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Conventionally, flight demands are calculated based on a history of aggregated seat purchase for a region or flights. Based on such flight demands, each airline broadly estimates a demand for a particular flight and as a result, may procure a vehicle or a plane that may be inadequate to meet actual demand, or alternatively, an overly large plane with many empty seats remaining, leading to inefficient fuel utilization. Moreover, in the first scenario, for the unaccommodated overbooked passengers, their respective flights are required to be rebooked on another flight, which may place additional pressure on the computing systems of the airlines that may potentially lead to a crash and additionally create unaccounted for demand for a subsequent flight, exacerbating the problem. In view of the above, a more tailored prediction of flight demand per airline and per flight may be desirable for proper procurement of vehicle type and to reduce resource burdens on aging computing systems utilized by the airlines.

### SUMMARY

According to an aspect of the present disclosure, a method of predicting demand at an airline level for a future flight path for procurement of an appropriate number and type of an aircraft. The method includes acquiring and aggregating raw data, over a communication network and from one or more servers; parsing, via a processor, the acquired raw data and identifying and aggregating a plurality of segments of location pairs; building, via a computer model executed by the processor, a plurality of connections based on the aggregated plurality of segments of location pairs, wherein each of the plurality of segments of location pairs is serviced by an aircraft of at least one of a plurality of airlines; for each of the plurality of segments of location pairs, generating, via the processor, a quality of service index (QSI) coefficient for each of the plurality of airlines; determining, via the computer model executed by the processor, a connection window for one or more connection flights based on the aggregated plurality of segments of location pairs; generating, via the processor and for each of the plurality of segments of location pairs, a circuitry curve based on a distance of a segment of a location pair; determining, via the processor, flight share information at an airline level for a target segment of location pair based on a corresponding QSI coefficient and a corresponding circuitry curve; determining, via the processor, agency gap values at the airline level for the target segment of location pair based on the flight share information; and updating the computer model, via the processor, based on the flight share information and the agency gap values for predicting at least one of a number of seats expected for the target segment of location pair for a target airline and a corresponding aircraft type for the target segment of location pair.

According to another aspect of the present disclosure, the method further includes transmitting, to a computer of the target airline, at least one of the number of seats expected for the target segment of location pair and the corresponding type of aircraft for the target segment of location pair; and assigning, by the computer of the target airline, the corresponding type of aircraft for the target segment of location pair.

According to another aspect of the present disclosure, the building of the plurality of connections includes: applying, via the processor, one or more limits of air service restrictions; reconstructing, via the processor, one-stop connections using the parsed raw data; applying, via the processor, a minimum connect time for the reconstructed one-stop connections; applying, via the processor, a maximum connect time for the reconstructed one-stop connections; building, via the processor, one or more exception rules for the reconstructed one-stop connections; and building, via the processor, double-stop connections.

According to yet another aspect of the present disclosure, the minimum connect time is determined by: performing a matching operation between two or more values of an inbound airline, an outbound airline, a domestic or international indicator, and an interline or online indicator; and selecting a minimum connect time associated with a matching record.

According to another aspect of the present disclosure, the maximum connect time is determined based on a combination of the domestic or international indicator for each segment of location pair included in the one-stop connections.

According to a further aspect of the present disclosure, the maximum connect time is further determined based on the interline or online indicator for each segment of location pair included in the one-stop connections.

According to yet another aspect of the present disclosure, the generating of the QSI coefficient includes: applying one or more QSI factor values based on a type of flight and an aircraft type.

According to a further aspect of the present disclosure, the type of flight includes at least one of a non-stop flight and an one-stop flight.

According to another aspect of the present disclosure, the aircraft type includes at least one of a wide-body jet, a medium-body jet, a narrow-body jet, a regional jet, and a turboprop.

According to a further aspect of the present disclosure, different coefficient values are used for different seat numbers for all non-stop flights.

According to a further aspect of the present disclosure, a slope and intercept values of a circuitry curve corresponding to non-stop flights are utilized to calculate a QSI factor value for the aircraft type.

According to a further aspect of the present disclosure, each of the wide-body jet, the medium-body jet, the narrow-body jet, the regional jet, and the turboprop aircraft types has different seat capacity.

According to a further aspect of the present disclosure, the connection window includes at least one minimum connect time and at least one maximum connect time, and a corresponding QSI factor penalty for a connect time outside of the connection window.

According to a further aspect of the present disclosure, different QSI factor penalty values are applied based on a total dwell time between connecting segments of location pairs.

According to a further aspect of the present disclosure, each of the plurality of circuitry curves is based on a distance between each segment of location pair.

According to a further aspect of the present disclosure, the flight share information at the airline level is determined by: for each segment of location pair of the plurality of segments of location pairs, multiply a service count by an airline with a corresponding QSI factor value.

According to a further aspect of the present disclosure, the flight share information at the airline level is determined by: for each segment of location pair of the plurality of segments of location pairs serviced by an airline, divide a QSI factor for the respective segment of location pair and divide by a sum of QSI factors of all of the plurality of airlines.

According to a further aspect of the present disclosure, the agency gap values at the airline level is determined by determining an agency share per airline for a segment of location pair and determining a difference between the agency share and the market share information.

According to an aspect of the present disclosure, a system for predicting demand at an airline level for a future flight path for procurement of an appropriate number and type of an aircraft is provided. The system includes a memory, a display and a processor. The system is configured to perform: acquiring and aggregating raw data, over a communication network and from one or more servers; parsing the acquired raw data and identifying and aggregating a plurality of segments of location pairs; building, via a computer model, a plurality of connections based on the aggregated plurality of segments of location pairs, wherein each of the plurality of segments of location pairs is serviced by an aircraft of at least one of a plurality of airlines; for each of the plurality of segments of location pairs, generating a QSI coefficient for each of the plurality of airlines; determining, via the computer model, a connection window for one or more connection flights based on the aggregated plurality of segments of location pairs; generating, for each of the plurality of segments of location pairs, a circuitry curve based on a distance of a segment of a location pair; determining flight share information at an airline level for a target segment of location pair based on a corresponding QSI coefficient and a corresponding circuitry curve; determining agency gap values at the airline level for the target segment of location pair based on the flight share information; and updating the computer model based on the flight share information and the agency gap values for predicting at least one of a number of seats expected for the target segment of location pair for a target airline and a corresponding aircraft type for the target segment of location pair.

According to another aspect of the present disclosure, a non-transitory computer readable storage medium that stores a computer program for predicting demand at an airline level for a future flight path for procurement of an appropriate number and type of an aircraft is provided. The computer program, when executed by a processor, causing a system to perform operations including: acquiring and aggregating raw data, over a communication network and from one or more servers; parsing the acquired raw data and identifying and aggregating a plurality of segments of location pairs; building, via a computer model, a plurality of connections based on the aggregated plurality of segments of location pairs, wherein each of the plurality of segments of location pairs is serviced by an aircraft of at least one of a plurality of airlines; for each of the plurality of segments of location pairs, generating a QSI coefficient for each of the plurality of airlines; determining, via the computer model, a connection window for one or more connection flights based on the aggregated plurality of segments of location pairs; generating, for each of the plurality of segments of location pairs, a circuitry curve based on a distance of a segment of a location pair; determining flight share information at an airline level for a target segment of location pair based on a corresponding QSI coefficient and a corresponding circuitry curve; determining agency gap values at the airline level for the target segment of location pair based on the flight share information; and updating the computer model based on the flight share information and the agency gap values for predicting at least one of a number of seats expected for the target segment of location pair for a target airline and a corresponding aircraft type for the target segment of location pair.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a quality of service index (QSI) system in accordance with an exemplary embodiment.

FIG. 2 illustrates an exemplary diagram of a network environment with a QSI system in accordance with an exemplary embodiment.

FIG. 3 illustrates a system diagram for implementing a QSI system in accordance with an exemplary embodiment.

FIG. 4 illustrates a method for vehicle procurement based on QSI based share information and agency share gap values in accordance with an exemplary embodiment.

FIG. 5 illustrates a method for building connections for modeling in accordance with an exemplary embodiment.

FIG. 6 illustrates a method for determining a minimum connect time for a connection point of an itinerary in accordance with an exemplary embodiment.

FIGS. 7A-7B illustrate an interface and corresponding code setting a range of minimum and maximum connect times based on flight types providing a connection flight in accordance with an exemplary embodiment.

FIG. 8 illustrates a table of applicable QSI factors in accordance with an exemplary embodiment.

FIGS. 9A-9C illustrate QSI calculation modes and graph for determining an applicable QSI values in accordance with an exemplary embodiment.

FIGS. 10A-10B illustrate determining and applying varying degrees of penalty based on dwell times and connection types in accordance with an exemplary embodiment.

FIG. 11 illustrates circuitry threshold curves with respect to mileage in accordance with an exemplary embodiment.

FIGS. 12A-12B illustrate a process for determining a QSI based share information at an itinerary level and a sample output table in accordance with an exemplary embodiment.

FIGS. 13A-13B illustrate a process in accordance with another exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

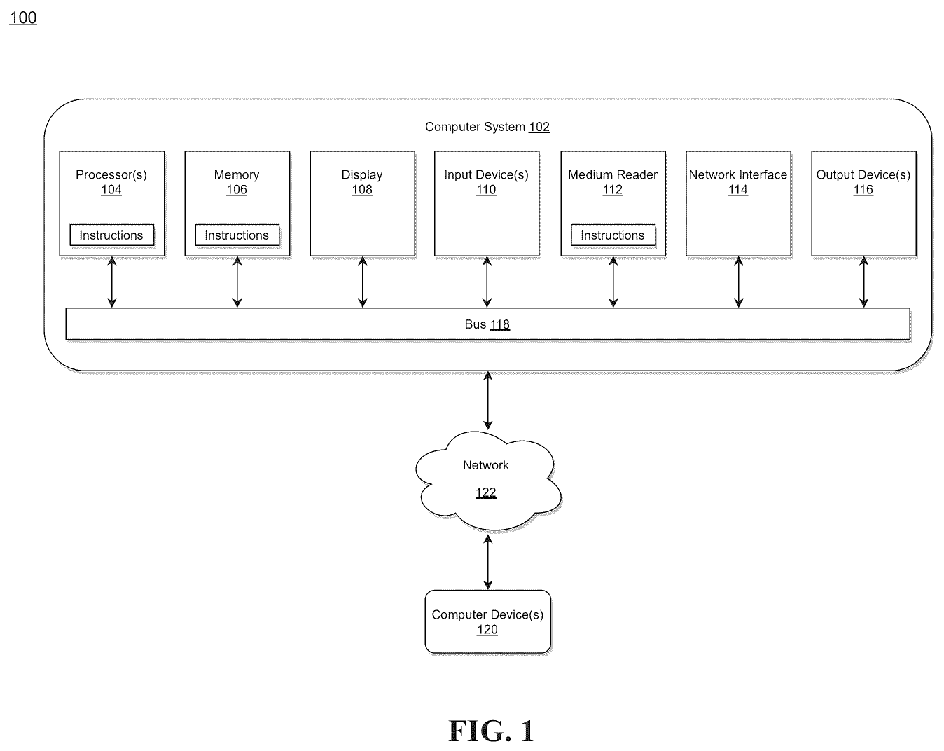

FIG. 1 illustrates a computer system for implementing a quality of service index (QSI) system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

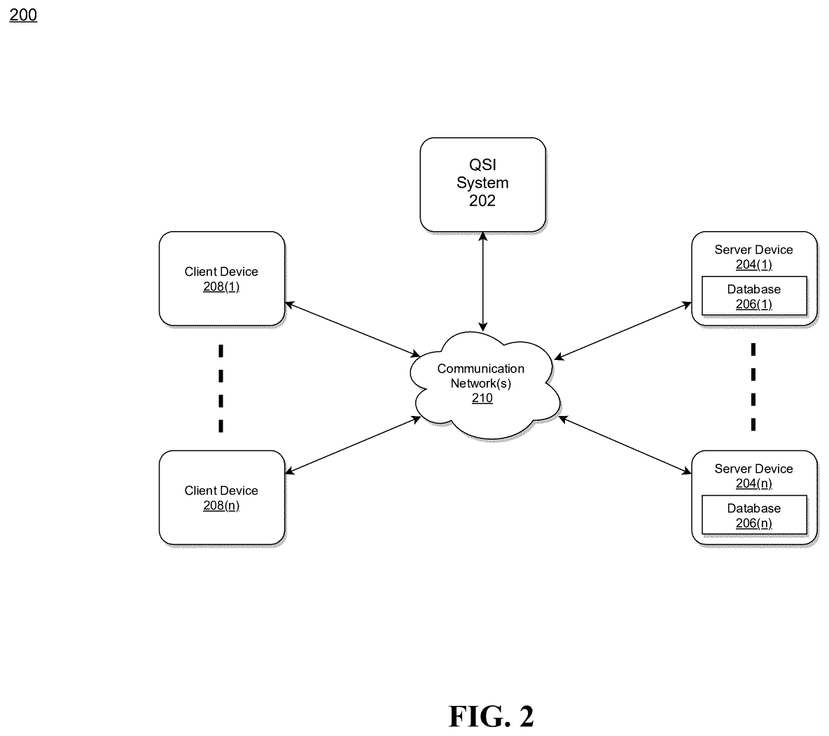

FIG. 2 illustrates an exemplary diagram of a network environment with a QSI system in accordance with an exemplary embodiment.

A QSI system 202 may be implemented with one or more computer systems similar to the computer system 102 as described with respect to FIG. 1.

The QSI system 202 may store one or more applications that can include executable instructions that, when executed by the QSI system 202, cause the QSI system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the QSI system 202 itself, may be located in virtual server(s) running in a cloud-based computing environment rather than being tied to one or more specific physical network computing devices. Also, the application(s) may be running in one or more virtual machines (VMs) executing on the QSI system 202. Additionally, in one or more embodiments of this technology, virtual machine(s) running on the QSI system 202 may be managed or supervised by a hypervisor.

In the network environment 200 of FIG. 2, the QSI system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the QSI system 202, such as the network interface 114 of the computer system 102 of FIG. 1, operatively couples and communicates between the QSI system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the QSI system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The QSI system 202 may be a standalone device or integrated with one or more other devices or apparatuses, such as one or more of the server devices 204(1)-204(n), for example. In one particular example, the QSI system 202 may be hosted by one of the server devices 204(1)-204(n), and other arrangements are also possible. Moreover, one or more of the devices of the QSI system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the QSI system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the QSI system 202 that may efficiently provide a platform for implementing a cloud native QSI system module, but the disclosure is not limited thereto.

The client devices 208(1)-208(n) may run interface applications, such as standard web browsers or standalone client applications, which may provide an interface to communicate with the QSI system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the QSI system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the QSI system 202, the server devices 204(1)-204(n), or the client devices 208(1)-208(n), for example, may be configured to operate as virtual instances on the same physical machine. For example, one or more of the QSI system 202, the server devices 204(1)-204(n), or the client devices 208(1)-208(n) may operate on the same physical device rather than as separate devices communicating through communication network(s) 210. Additionally, there may be more or fewer QSI systems 202, server devices 204(1)-204(n), or client devices 208(1)-208(n) than illustrated in FIG. 2. According to exemplary embodiments, the QSI system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

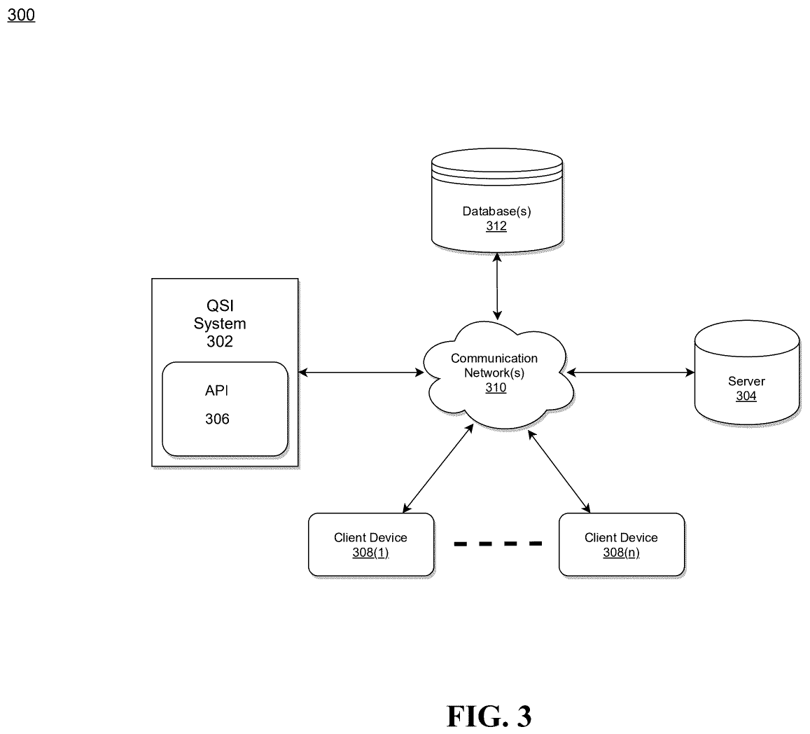

FIG. 3 illustrates a system diagram for implementing a QSI system in accordance with an exemplary embodiment.

As illustrated in FIG. 3, the system 300 may include a QSI system 302 within which a group of API modules 306 is embedded, a server 304, a database(s) 312, a plurality of client devices 308(1) . . . 308(n), and a communication network 310.

According to exemplary embodiments, the QSI system 302 including the API modules 306 may be connected to the server 304, and the database(s) 312 via the communication network 310. Although there is only one database that has been illustrated, the disclosure is not limited thereto. Any number of databases may be utilized. The QSI system 302 may also be connected to the plurality of client devices 308(1) . . . 308(n) via the communication network 310, but the disclosure is not limited thereto.

According to exemplary embodiment, the QSI system 302 is described and shown in FIG. 3 as including the API modules 306, although it may include other rules, policies, modules, databases, or applications, for example. According to exemplary embodiments, the database(s) 312 may be embedded within the QSI system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable QSI system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the QSI system 302. In this regard, the plurality of client devices 308(1) . . . 308(n) may be “clients” of the QSI system 302 and are described herein as such. Nevertheless, it is to be known and understood that the plurality of client devices 308(1) 308 (n) need not necessarily be “clients” of the QSI system 302, or any entity described in association therewith herein. Any additional or alternative relationship may exist between either or both of the plurality of client devices 308(1) . . . 308(n) and the QSI system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the QSI system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The QSI system 302 may be the same or similar to the QSI system 202 as described with respect to FIG. 2, including any features or combination of features described with respect thereto.

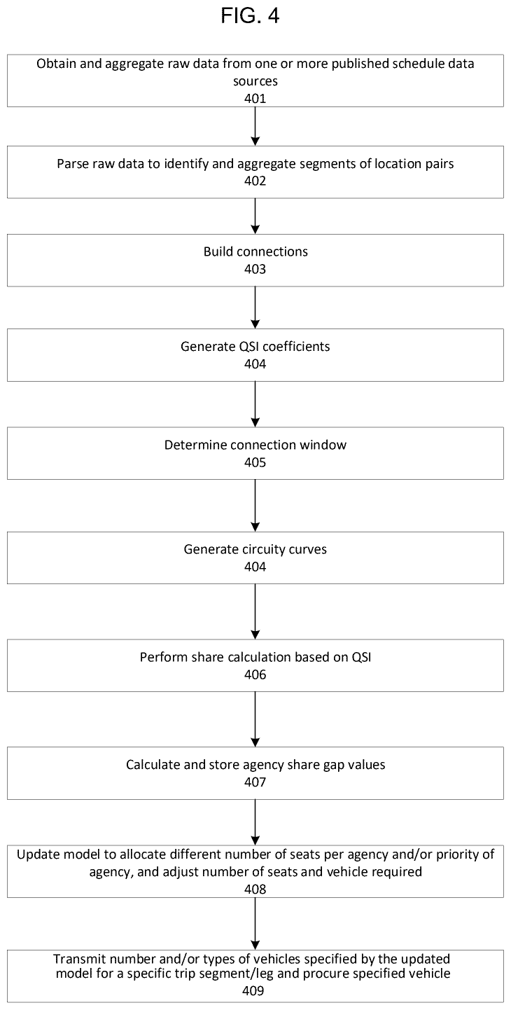

FIG. 4 illustrates a method for vehicle procurement based on QSI based share information and agency share gap values in accordance with an exemplary embodiment.

According to exemplary aspects, a method and system for predicting a fare market share per airline for future scheduled travel departures are provided. Such a method and system allows for users to quantify which airline provides best overall services in the given market for a period of time, and based on such quantifications, airlines may be able to better predict user demand for better resource (i.e., airplanes) procurement to ensure adequate number of seats to reduce or avoid overselling of seats.

More specifically, according to exemplary aspects, the QSI system and method may be able to predict customer behavior by quantifying relative attractiveness of flight options by market (e.g., origin and destination (O&D) city pair) from published airline schedules.

According to exemplary aspects, instead of using a passenger share as a sole metric, the QSI system and method evaluates airlines' services on various attributes based on passengers' preferences. Preferences may include, without limitation, a passenger's preference for non-stop itineraries over connection flights, a passenger's preference for connections via the same carrier over connections serviced by different carriers, a size and/or model of the air craft and the like.

According to exemplary aspects, the QSI system and method may be transparent, and may allow for easy adjustment of results for specific markets or airlines. In this regard, the QSI system or method may utilize a model that assigns weights or points to airlines based on one or more schedule attributes. For example, every O&D itinerary in an O&D market may be scored or weighted based on schedule characteristics. These itineraries may be compared to other itineraries in the market for assigning of a corresponding share. Moreover, assignment weighting may be based on empirical consumer behaviors.

In operation 401, aggregating of raw data is performed from one or more published schedule data sources over a communication network. According to exemplary aspects, data sources may include servers or databases that reside on a publicly accessible network (e.g., government or agency) and/or servers or database that may reside over a privately accessible network (e.g., corporate). However, aspects of the present disclosure are not limited thereto, such that nonpublished data may also be aggregated.

In operation 402, the aggregated raw data may be parsed to identify and aggregate segments of location pairs. According to exemplary aspects, location pairs may include an origin and destination of a flight segment or leg. According to further aspects, the parsing of aggregated raw data may be performed in real-time as the raw data is aggregated or in a batch processing. For example, batch processing may be performed during off-peak hours to alleviate stress on computing resources. Alternatively, aggregated raw data may be parsed and processed in real-time to obtain more quickly and higher accuracy output.

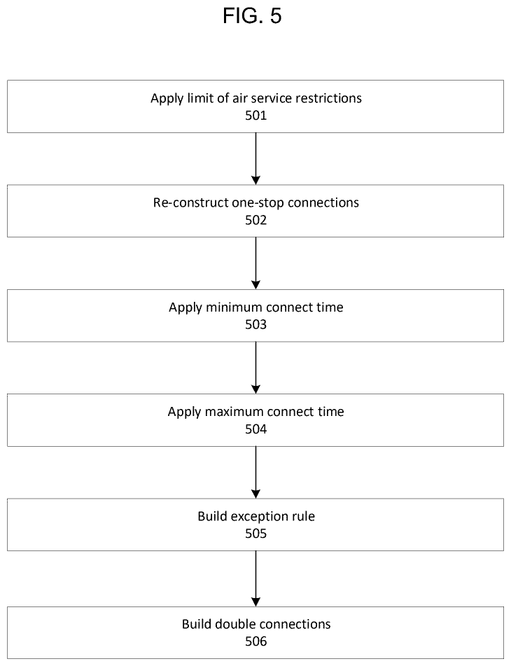

In operation 403, one or more connections are established, generated or otherwise built using the parsed aggregated raw data. A more detailed description of generating of the one or more connections is exemplarily described in more detail below with reference to FIGS. 5, 6 and 7A-7B. According to exemplary aspects, the one or more connections may be generated using a computer model, an artificial intelligence (AI) model or algorithm, a machine learning (ML) model or algorithm, or neural networks model or algorithm.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

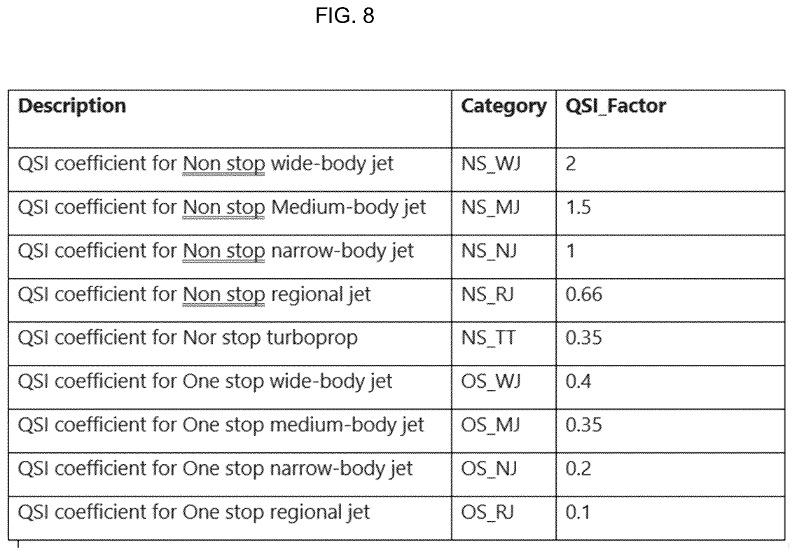

In operation 404, QSI coefficients may be generated. Detailed description of the QSI coefficient may be provided with respect to FIG. 8. FIG. 8 illustrates a table of applicable QSI factors in accordance with an exemplary embodiment. As exemplarily illustrated in FIG. 8, first part of the table is QSI coefficients used for different service types, such as non-stop, one-stop, single connection and double connection, by different equipment types, such as wide-body jets, narrow-body jets, regional jet, and turboprop. More specifically, as illustrated in FIG. 8, a combination of non-stop (NS) service type and a wide-body jet (WJ) equipment type may correspond to a category of NS_WJ and provide a QSI coefficient factor of 2. A combination of non-stop service type and a medium-body jet (MJ) equipment type may correspond to a category of NS_MJ and provide a QSI coefficient factor of 1.5. A combination of non-stop service type and a narrow-body jet (NJ) equipment type may correspond to a category of NS_NJ and provide a QSI coefficient factor of 1. A combination of non-stop service type and a regional jet (RJ) equipment type may correspond to a category of NS_RJ and provide a QSI coefficient factor of 0.66. A combination of non-stop service type and a turboprop (TT) equipment type may correspond to a category of NS_TT and provide a QSI coefficient factor of 0.35.

Further, a combination of one-stop (OS) service type and a wide-body jet equipment type may correspond to a category of OS_WJ and provide a QSI coefficient factor of 0.4. A combination of one-stop service type and a medium-body jet equipment type may correspond to a category of OS_MJ and provide a QSI coefficient factor of 0.35. A combination of one-stop service type and a narrow-body jet equipment type may correspond to a category of OS_NJ and provide a QSI coefficient factor of 0.2. A combination of one-stop service type and a regional jet equipment type may correspond to a category of OS_RJ and provide a QSI coefficient factor of 0.1. As shown above, non-stop service type contributes to the highest QSI factor. However, aspects of the present disclosure are not limited thereto, such that different service types and/or equipment types may provide for different QSI factor values. In addition, wide-body jet equipment type may contribute to the highest QSI factor. According to exemplary aspects, for codeshare services, a codeshare multiplier may be applied.

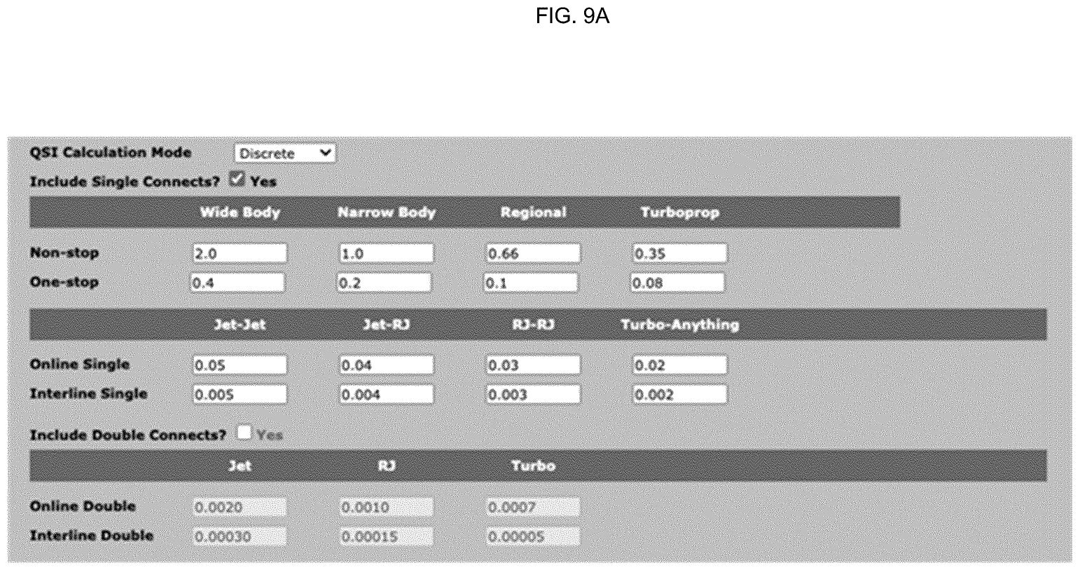

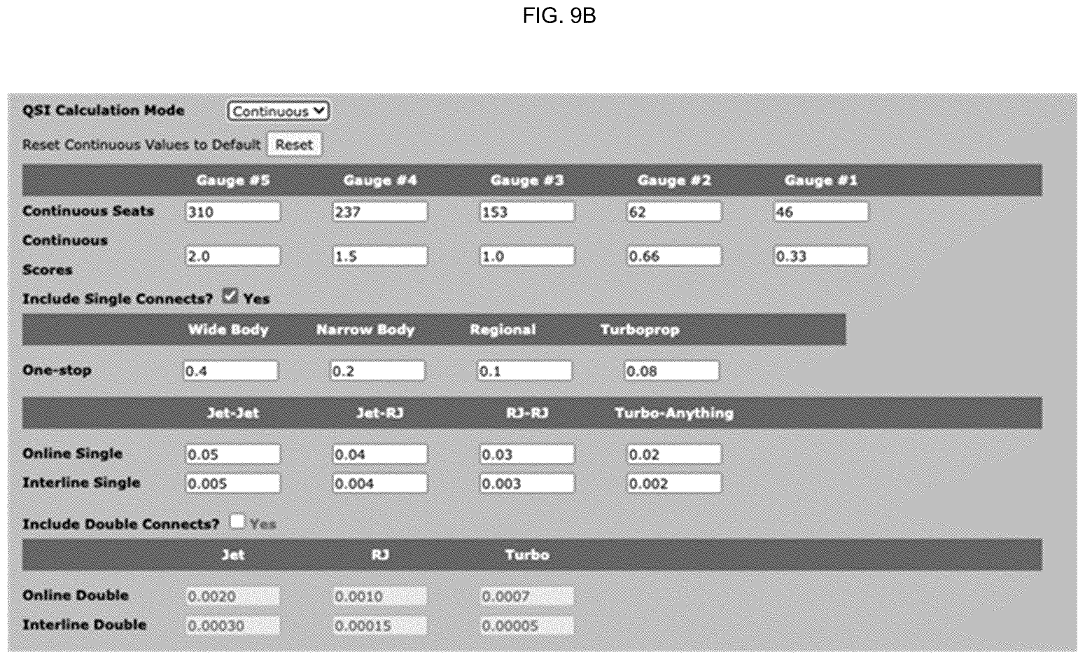

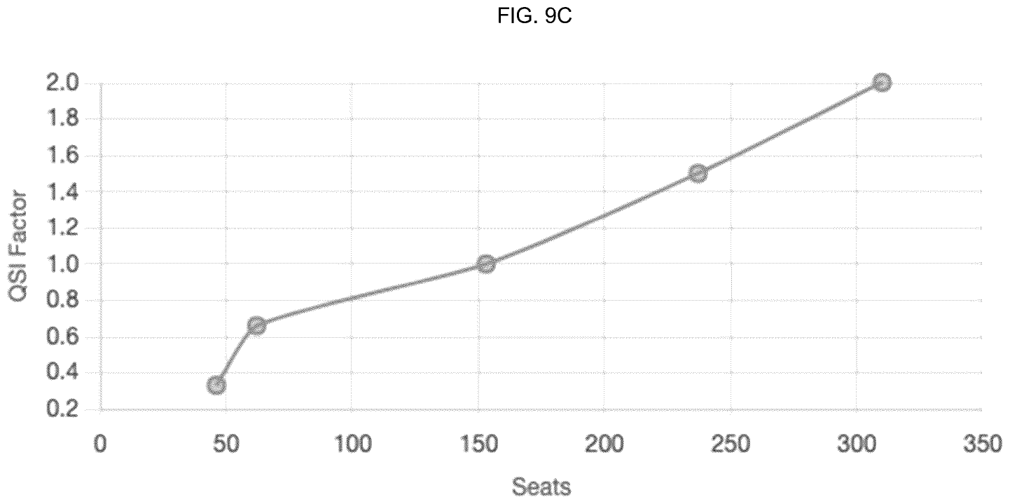

According to further aspects, two approaches may be used to create airline market share datasets. The two approaches may include discrete and continuous as exemplarily illustrated in FIGS. 9A-9B. One of the two approaches may be selected for utilization based on the value of a continuous field. In an example, 0 for the continuous field may indicate a discrete method while a value of 1 may indicate a continuous method.

When the discrete method is used, five categories may be used for non-stop records. The five categories may include, wide-body, medium-body, narrow-body, regional and turboprop. When an aircraft type is not available in a database or data table, one of the five categories may be designated based on seat numbers provided in schedule data. For example, when seat numbers are greater than 300, then wide-body category may be designated. If the seat numbers are greater than 200 but less than or equal to 300, then the medium-body category may be designated. If the seat numbers are greater than or equal to 100 but less than or equal to 200, then the narrow-body category may be designated. If the seat numbers are greater than 65 but less than or equal to 100, then the regional jet category may be assigned. Lastly, if the seat numbers are less than or equal to 65, then the turboprop category may be assigned.

For single connections, online connections may be separated from interline connections, and then further divided into five categories, including (i) wide-body jet-wide-body jet, (ii) non-wide-body jet-jet, (iii) jet-regional jet, (iv) regional jet-regional jet, and (v) turboprop-any equipment type. According to exemplary aspects, an online connection may refer to an itinerary with the same operating airline on all of its legs. All other connecting itineraries are considered interline connections.

For double connections, online connections may be separated from interline connections, and the further divided into three categories, including (i) jet, (ii) regional jet, and (iii) turboprop. According to exemplary aspects, as long as one leg is operated by a regional jet and all legs are operated by a jet, the itinerary may be categorized as a regional jet. On the other hand, as long as one leg is operated by a turboprop, the itinerary is categorized as turboprop.

FIGS. 9A-9C illustrate QSI calculation modes and graph for determining an applicable QSI values in accordance with an exemplary embodiment. As exemplarily illustrated in FIG. 9A, when a discrete QSI calculation mode is utilized, a QSI factor value may be applied according to a combination of service type and equipment type. Alternatively, different QSI factor value may be applied according to a combination of an online single connection and corresponding categories (e.g., jet-jet, jet-RJ, RJ-RJ, and turboprop and any equipment type), and a combination of an interline single connection and corresponding categories. Also, different QSI factor value may be applied according to a combination between online double connections and corresponding categories (e.g., jet, RJ and turboprop), and a combination of interline double connections and corresponding categories.

FIG. 9B exemplarily illustrates a continuous QSI calculation mode. According to exemplary aspects, when the continuous method is utilized, a QSI coefficient may be used for each different seat number for all non-stop records. In other words, QSI coefficient value may be determined at a seat level, as opposed to at a flight level. In an example, formula for one-stops, single connections, an double connections may be same as those in the discrete method.

According to exemplary aspects, the specific QSI factor used for a flight with a specific seat number may be determined by a line segment. For example, as exemplarily illustrated in the QSI factor table of FIG. 9C, five points are defined from (gauge 1, value 1) to (gauge 5, value 5). Five straight line formulas may be derived based on those five points and the origin point (0, 0). In the FIG. 9C, the first segment between the origin point and the first gauge point is not shown. The slope and intercept values of those five-line segments may also be stored in the QSI factor table as slope 1-5 and intercept 1-5. The slope and intercept value may be used to calculate QSI scores for non-stop records. For example, if a non-stop record has a seat number 100, the QSI coefficient may be calculated by 0.00373626*100+0.42835165=0.802. At least since 100 falls between the second gauge point (62, 0.66) and the third gauge point (153, 1.0), the QSI factor should be between 0.66 and 1.0. Therefore, the formula with slope 3 (0.00373626) and intercept 3 (0.42835165) may be utilized.

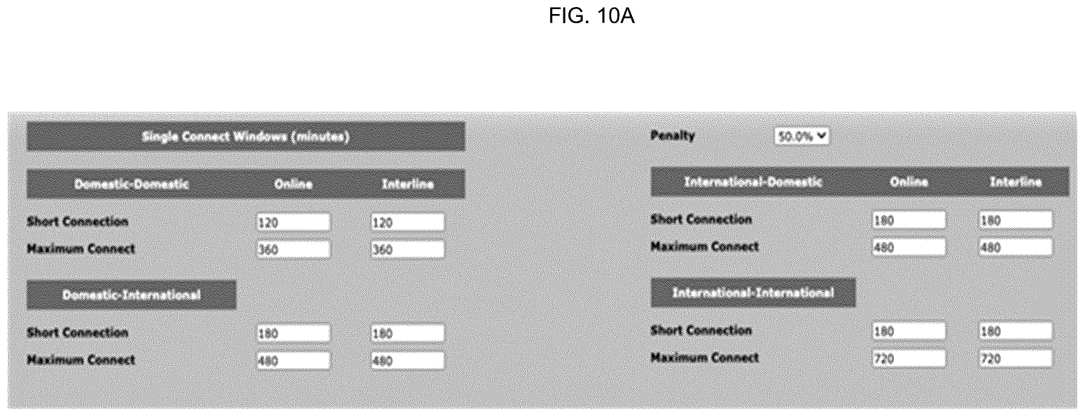

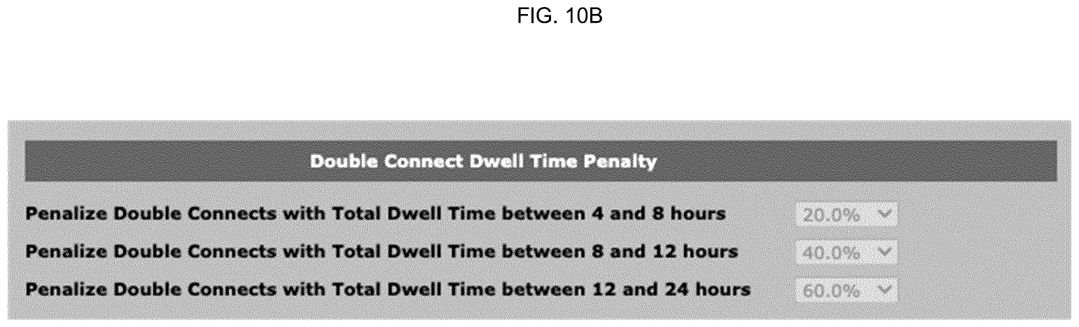

In operation 405, a connection window may be determined. According to exemplary aspects, one or more penalties may be applied on connections with long dwell times. In an example, a predetermined default penalty factor (0.5) for a single connection may be set. However, whether a single connection has a long dwell time may depend on whether the flight is domestic or international, and online or interline. According to exemplary aspects, FIG. 10A illustrates parameters that may be used for single connections. For example, if the first flight is domestic, the second flight is domestic and the operating carrier may be the same for both flights, then 120 minutes (2 hours) may be utilized as the cut time for short connections. According to exemplary aspects, same or different values may be utilized for online and interline. In the above example, if a connection has a dwell time longer than 120 minutes, the QSI score may be multiplied by the predetermined default penalty factor.

As further illustrated in FIG. 10A, different cut times may be set for domestic-international, international-domestic, and international-international connection flights. For example, although the cut time was set to 120 minutes for short connections in domestic-domestic connection flight, 180 minutes is set for the domestic-international, international-domestic, and international-international connection flights. Different cut times are indicated for the maximum cut time.

While single connections may have one dwell time, double connections may have two. According to exemplary aspects, the number of dwell times may correspond to the number of connections. For the double connections, the dwell times may be added together, and a predetermined number of categories (e.g., three) may be generated and then corresponding penalty factors may be applied during the QSI value calculation. An exemplary listing of categories and corresponding range of dwell times and penalty values is exemplarily illustrated in FIG. 10B. As illustrated in FIG. 10B, the three categories may include (i) total dwell time between a first range of values (e.g., 4-8 hours), resulting in a first penalty value (e.g., 0.2), (ii) total dwell time between a second range of values (e.g., 8-12 hours), resulting in a second penalty value (e.g., 0.4), and (iii) total dwell time between a third range of values (e.g., 12-24 hours), resulting in a third penalty value (e.g., 0.6). Although three categories, range of values and penalty values are specified herein, aspects of the present disclosure are not limited thereto, such that greater number of categories, range of values and penalty values may be utilized.

In operation 404, circuitry curves may be generated. According to exemplary aspects, circuitry may refer to a sum of segment distances divided by a direct distance between the true origin and destination (O&D). Because non-stop itineraries may have only a single segment, circuitry may be equal to 1. All other itineraries have a circuitry greater than equal to 1.

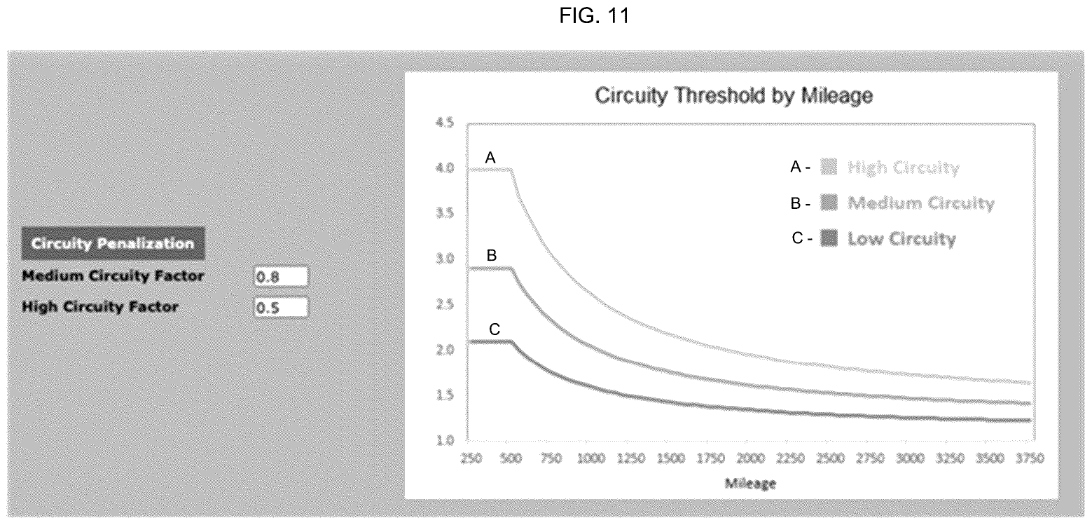

In an example, three circuitry curves may be defined, namely, high or first circuitry, medium or second circuitry, and low or third circuitry. The three exemplary circuitry curves are illustrated on FIG. 11. The circuitry threshold values with respect to mileage are illustrated in FIG. 11. Y axis values may refer to circuitry values, and the X axis values may refer to mileage. Moreover, circuitry penalization factor values are provided for medium circuitry and low circuitry.

The circuitry curves may provide different methods for providing circuitry values based on the O&D distance. More specifically, a default value may be applied for one set of O&D distances and a formula may be provided for calculating a circuitry value for other set of O&D distances. For example, the high or first circuitry may specify that if origin and destination distance is less than a threshold value of miles (e.g., 500 miles), then a default circuitry value (e.g., 4.0) may be utilized. For other distances, circuitry value may be calculated by dividing a first constant value by the O&D distance and then adding a second constant value (i.e., circuitry value=a first constant/O&D distance+a second constant).

The medium or second circuitry may specify that if origin and destination distance is less than a threshold value of miles (e.g., 500 miles), then a default circuitry value (e.g., 2.9) may be utilized. For other distances, circuitry value may be calculated by dividing a third constant value by the O&D distance and then adding a fourth constant value (i.e., circuitry value=a third constant/O&D distance+a fourth constant). According to exemplary aspects, the third constant is less than the first constant, and the fourth constant is less than the second constant.

The low or third circuitry may specify that if origin and destination distance is less than a threshold value of miles (e.g., 500 miles), then a default circuitry value (e.g., 2.1) may be utilized. For other distances, circuitry value may be calculated by dividing a fifth constant value by the O&D distance and then adding a sixth constant value (i.e., circuitry value=a fifth constant/O&D distance+a sixth constant). According to exemplary aspects, the fifth constant is less than the third constant, and the sixth constant is less than the fourth constant.

According to exemplary aspects, during the connection process, all itineraries with circuitry above the high or first circuitry curve may be removed. Moreover, during the QSI value calculation, a first circuitry factor (e.g., 0.5) may be applied to itineraries with circuitry between the medium or second circuitry curve and the high or first circuitry curve. In addition, a second circuitry factor (e.g., 0.8) may be applied for itineraries with circuitry between the low or third circuitry curve and the medium or second circuitry curve. No penalty or a circuitry factor of 1.0 may be applied for itineraries with circuitry below the low or third circuitry curve. According to exemplary aspects, the first circuitry factor is less than the second circuitry factor, and both the first circuitry factor and the second circuitry factor is below 1.0.

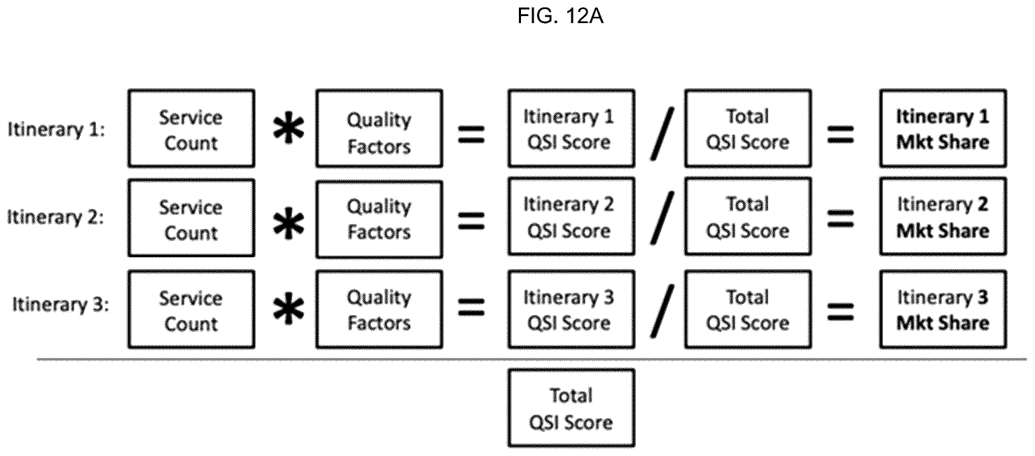

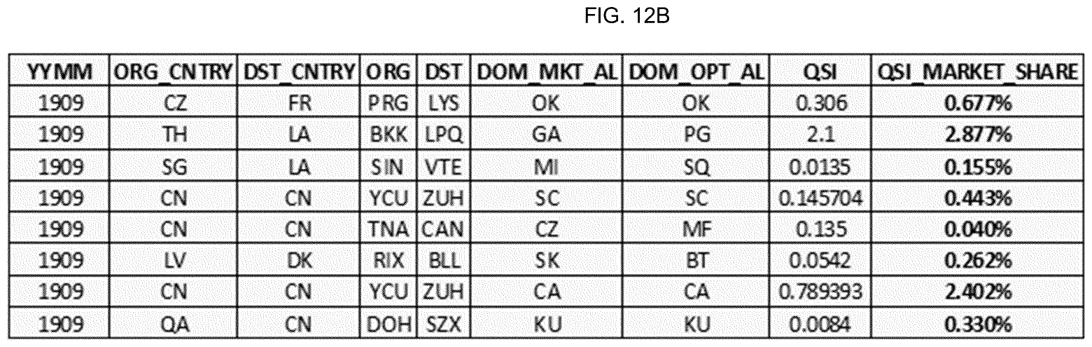

In operation 405, market share calculation is performed. According to exemplary aspects, market share may be calculated based on individual itinerary QSI value divided by a market total QSI value. As exemplarily illustrated in FIG. 12A, market share calculations based on QSI values are performed on itinerary 1, itinerary 2 and itinerary 3.

As illustrated in FIG. 12A, itinerary 1 market share may be calculated by dividing itinerary 1's QSI score by the total QSI score. Alternatively, the itinerary 1 market share may be calculated by multiplying a service count with quality factors. According to exemplary aspects, and as exemplarily illustrated in FIG. 12A, a value calculated by multiplying a service count of itinerary 1 with quality factors of itinerary 1 may equal to a value calculated by dividing itinerary 1's QSI score by the total QSI score. Marke share information for itinerary 2 and itinerary 3 may be calculated similarly as described above.

Unlike conventional practices of determining market share by geographic boundaries (e.g., countries, regions and etc.), the above noted methodology allows for airlines to identify demand or market share according to specific routes, allowing for more accurate forecasting. Here, at least since airlines may be able to more accurately determine passenger demands for particular routes or itineraries, a more accurate seat or aircraft requirements may be determined to lower instances of overselling of flights and unnecessary delays. Moreover, at least since overselling of flights and/or rebooking of flights may be reduced, processing and/or storage burdens on computing infrastructure, as well as network infrastructure may be reduced to provide for a more predictable and stable computing environment. In addition to the above, at least since the above noted methodology allows for more accurate identification of seat or aircraft requirements, advanced procurement of correct number of aircrafts may be performed by corresponding airlines for more efficient servicing of passengers and to ensure sufficient number of seats are available.

According to exemplary aspects, QSI scores may be calculated based on different service types. The different service types may include, without limitation, non-stop service, one-stop service, single connection service and double connection service. FIG. 12B exemplarily illustrates QSI values and QSI market share values for various flights.

In operation 407, agency share gap values may be calculated and stored. According to exemplary aspects, the QSI model may remain incomplete without having an ability to track travel agency entity performance with agency share gap process in QSI, which may allow tracking of how each seat selling entities are performing compared to expected QSI for a particular itinerary market (i.e., origin and destination pair) over a respective period of time.

According to exemplary aspects, actual market share may refer to an expected market share, and the share gap may be based on travel records with various keys for each agency. The various keys include travel month, marketing carrier, operating carrier, origin airport and destination airport. Moreover, only carriers with agent sales may be included. Direct sales of airlines using agents may be included. In this regard, agent field may indicate “none” for the respective market share of airline.

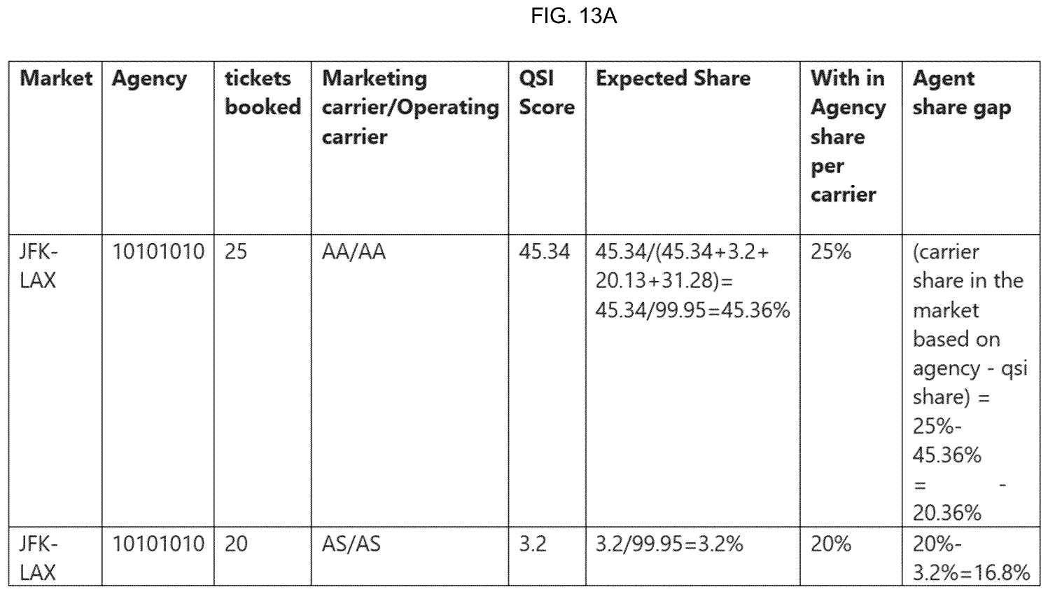

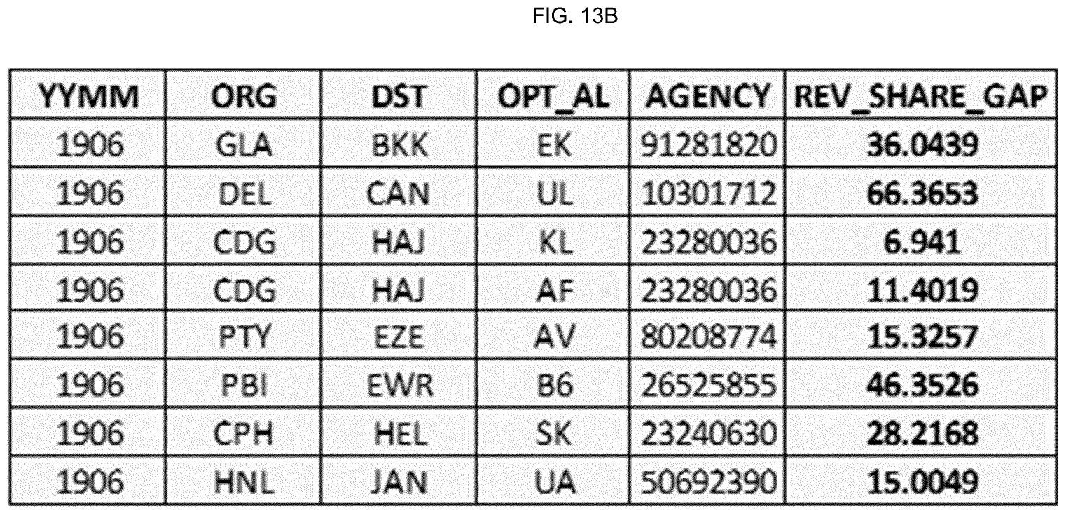

According to further aspects, agent share gap values may be calculated based on the QSI scores generated in the above noted steps. FIG. 13A exemplarily illustrates how agent share gap may be calculated. As illustrated in FIG. 13A, agency 10101010 booked 25 tickets for the JFK-LAX market operated by AA carrier. QSI score of 45.34 is divided by total QSI score of 99.95 to provide an expected share of 45.36%. The expected share information is then compared against agency share per carrier value of 25%. Based on these two values, agent share gap of 20.36% may be determined.

In view of the above noted exemplary calculations of FIG. 13A, an output may be provided listing timeframe (year and month (YYMM), origin (ORG), destination (DST), airline (OPT_AL), agency identifier (AGENCY), and revenue share gap by respective agency (REV_SHARE_GAP) as exemplarily illustrated by FIG. 13B.

In operation 408, the machine learning model may be updated to reflect the determined share calculations and agency gap values, and allocate different number of seats per agency and/or priority of agency to the available seats at a trip segment/leg level (between an origin and a destination) based on the determined share calculations based on QSI and agency gap values. Moreover, number of seats required for the respective trip segment/leg may be determined as well as the vehicle type for the trip segment/leg may be adjusted based on the updated model. Accordingly, in view of the share calculations based on QSI, agency gap values and the updated machine learning model, an amount of overbooked tickets and rebooking of tickets may be reduced for more efficient utilization of computing resources as well as more efficient allocation of vehicles (e.g., aircrafts) may be performed, for more efficient fuel usage and passenger satisfaction.

In operation 409, outputs of the machine learning model may be transmitted to one or more airlines specifying a number and/or a vehicle type required for a specified trip segment/leg based on the adjusted QSI share information for procurement, and the specified number and vehicle type may be procured for the specified trip segment/trip.

FIG. 5 illustrates a method for building connections for modeling in accordance with an exemplary embodiment.

In operation 501, one or more limitations of air service restrictions may be applied. For example, limitations of air service restrictions may include, without limitation, restriction of percentage value and one or more rules for avoiding building of invalid connections.

According to exemplary aspects, percentage value may be initially restricted to a value of 1, which may indicate that the airline is unable to take any local traffic on the flights. However, aspects of the present disclosure are not limited thereto, such that a different value or values may be utilized to indicate the inability to take local traffic. In an example, a foreign marketing carrier may utilize a domestic operating partner's flight to connect to another flight for a foreign destination. More specifically, the foreign marketing carrier may carry passengers on international connections using one or more domestic legs (e.g., flights between an origin and destination) but it may be unable to sell tickets on those domestic destinations. However, in certain cases, a carrier may be able to sell tickets on the local origin and destination (O&D) starting middle (or some other time) of a month. In such cases, the restrict percentage may be modified to indicate a fractional number.

According to aspects, for connections, various rules may be applied to avoid building of invalid connections. Rules for avoiding building of invalid connections may include cabotage rules, which specific that a foreign airline may not have itineraries with domestic true O&D pairs. For example, British Airways (BA) may not be permitted to have an O&D record of LAX-JFK because that O&D belongs to US domestic market. Rules for avoiding building of invalid connections may also specify that an itinerary with domestic O&D cannot connect at a foreign airport except in the European Union (EU) and Australia or New Zealand. However, the specified geographic boundaries are not limited thereto, such that different countries, regions, continents or the like may be specified. Other rules for avoiding building of invalid connections may also specify that low-cost carriers (LCC) have limited connections below a reference amount, and that no interline connections may be permitted in the US while permitting codeshare connections.

In an example, the rules applied may be set or modified manually or via a machine learning algorithm. More specifically, through multiple iterations, a machine learning algorithm model may be modified or updated to recognize which set rule results in creation of an invalid connection and may autonomously remove such rules to provide a more accurate machine learning algorithm model.

In operation 502, reconstruction of one-stop connections is performed. To ensure that the output contains complete routing information, the one-stop and two-stop direct services may be reconstructed. This approach may be utilized to join the non-stop itinerary table with itself to ensure one or more criteria are satisfied. The one or more criteria may include, without limitation, (i) origin airport of the second leg is the same destination airport of the first leg, (ii) both legs have the same operating carrier and the same flight number, and (iii) departure time of the second leg is between a first number (e.g., 5) minutes and a second number (e.g., 20) hours after the arrival time of the first leg. According to exemplary aspects, the first number may refer to the minimum number and the second number may refer to the maximum number. According to further aspects, the minimum connecting time and the maximum connecting time may not apply to the one-stop services because those connecting flights may always be deemed valid.

In operation 503, the minimum connect time may be applied. According to exemplary aspects, the connection building may include a process of combining two flights to ensure a passenger from the first flight is able to get on the second flight. In this regard, a reasonable time range may be set between the arrival time of the first flight and the departure time of the second flight. In an example, the lower end of that range may be referred to as a minimum connecting time or first threshold connecting time, and the higher end may be referred to as a maximum connecting time or second threshold connecting time. However, aspects of the present disclosure are not limited thereto, such that the first threshold connecting time does not have to be the minimum value and/or the second threshold connecting time does not have to be the maximum value.

According to exemplary aspects, the minimum connect time or first threshold connecting time may show or indicate a legal minimum connect time for each airport for every departing/arriving airline. In an example, the minimum connect time data may be provided by a third party source, which may be loaded into QSI system.

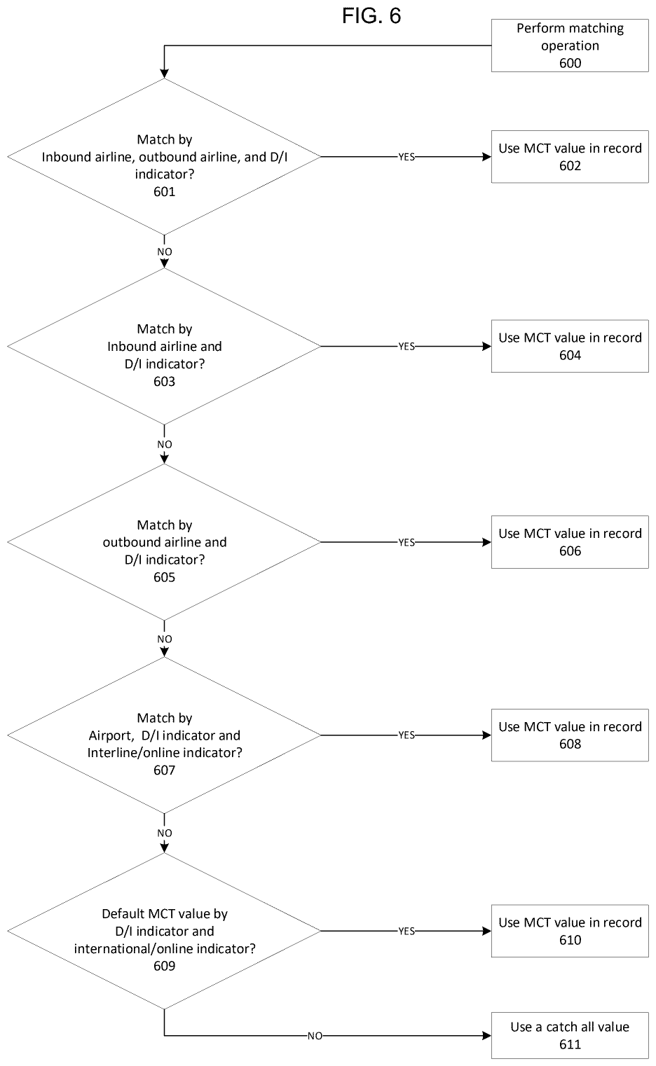

According to exemplary aspects, a hierarchy model may be utilized to determine which minimum connect time or first threshold connecting time value is to be used. An exemplary hierarch model may be described with reference to FIG. 6 below.

FIG. 6 illustrates a method for determining a minimum connect time for a connection point of an itinerary in accordance with an exemplary embodiment. For determination of which minimum connect time or first threshold connecting time to use among multiple values, a matching operation 600 may be performed between multiple variables to determine. The multiple variables may include, without limitation, an inbound airline, an outbound airline, a domestic/international (D/I) indicator, and an interline/online (I/O) indicator.

In operation 601, a determination of whether there is a match between an inbound airline, an outbound airline and a D/I indicator. If a match between the three values exist, then the minimum connect time value in the respective record is utilized in operation 602. If no match exists between the inbound airline, the outbound airline and the D/I indicator, then the method proceeds to subsequent operations.

In operation 603, a determination of whether there is a match between an inbound airline and a D/I indicator. If a match between the two values exist, then the minimum connect time value in the respective record is utilized in operation 604. If no match exists between the inbound airline and the D/I indicator, then the method proceeds to subsequent operations.

In operation 605, a determination of whether there is a match between an outbound airline and a D/I indicator. If a match between the two values exist, then the minimum connect time value in the respective record is utilized in operation 606. If no match exists between the outbound airline and the D/I indicator, then the method proceeds to subsequent operations.

In operation 607, a determination of whether there is a match between an airport, a D/I indicator and an interline/online indicator. If a match between the three values exist, then the minimum connect time value in the respective record is utilized in operation 608. If no match exists between the airport, the D/I indicator and the interline/online indicator, then the method proceeds to subsequent operations.

In operation 609, a determination of whether there is a match between a D/I indicator and an interline/online indicator. If a match between the two values exist, then the minimum connect time value in the respective record is utilized in operation 610. If no match exists between the D/I indicator and the interline/online indicator, then a set catch-all value is utilized in operation 611. According to exemplary aspects, the catch-all value may be manually set (e.g., 5 minutes) or autonomously set or adjusted according to a machine learning model.

In operation 504, the maximum connect time is applied. According to exemplary aspects, the maximum connecting time or the second threshold connecting time may depend on whether the connecting flights are (i) domestic or international, and (ii) online or interline. According to further aspects, the maximum connecting time or the second threshold connecting time may be utilized for different combinations. For example, if the first flight is domestic and the second flight may be domestic, and the operating carrier may be the same for both flights. In such a case, 360 minutes or 6 hours may be set as the cut time. According to exemplary aspects, same values for online and interline may be utilized. However, aspects of the present disclosure are not limited thereto, such that different values for the online and interline may be utilized.

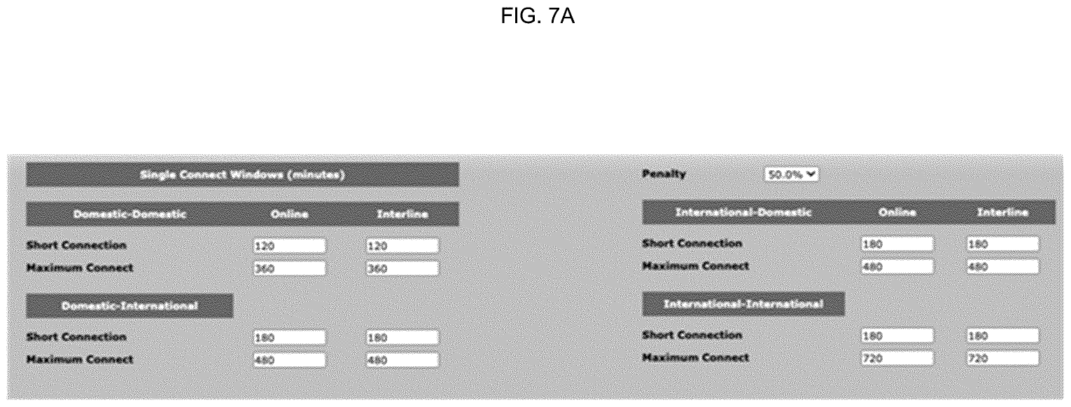

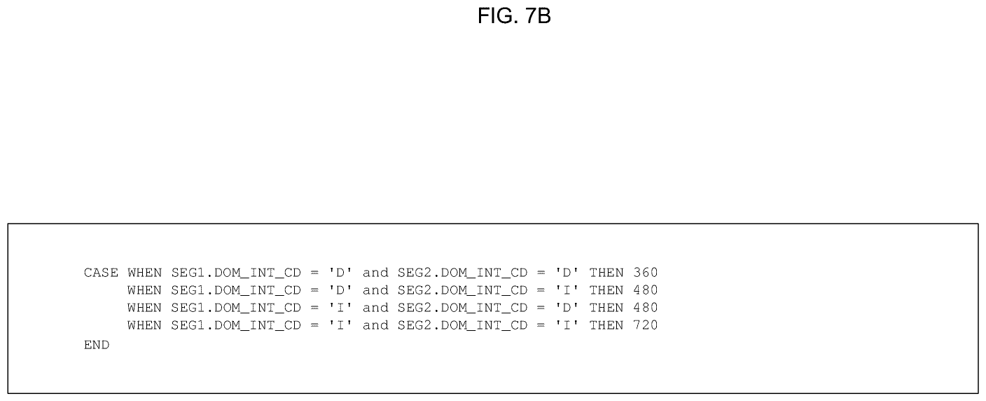

An example for setting or applying the minimum connect time and maximum connect times for different types of flights on a user interface is illustrated in FIGS. 7A-7B. FIGS. 7A-7B illustrate an interface and corresponding code setting a range of minimum and maximum connect times based on flight types providing a connection flight in accordance with an exemplary embodiment. As illustrated in FIG. 7A, for single connection flights, when the first flight and the second flight are both domestic, minimum connect time or short connection may be set for 120 minutes for both online and interline, and maximum connect time or maximum connect may be set for 360 minutes for both online and interline. On the other hand, when the first flight is a domestic flight and the second flight is an international flight, minimum connect time or short connection may be set for 180 minutes for both online and interline, and maximum connect time or maximum connect may be set for 480 minutes for both online and interline. Similarly, when the first flight is an internation flight and the second flight is a domestic flight, minimum connect time or short connection may be set for 180 minutes for both online and interline, and maximum connect time or maximum connect may be set for 480 minutes for both online and interline. Lastly, when both of the first flight and the second flight are international flights, minimum connect time or short connection may be set for 180 minutes for both online and interline, and maximum connect time or maximum connect may be set for 720 minutes for both online and interline.

An exemplary code for the connection building process is illustrated in FIG. 7B. According to exemplary aspects, the code illustrated in FIG. 7B may be utilized to limit output in the connection table. In this regard, preemptive setting of limits may reduce amount of output for reduced memory storage requirement and processing load imposed on processing hardware for more efficient utilization of computing resources. According to further aspects, such code may provide an absolute upper limit for connecting times. In an example, the limit values may be hard-coded. However, aspects of the present disclosure are not limited thereto, such that the limit values may be a variable value that may be adjusted or updated based on a machine learning model or based on monitoring of flight schedules.

More specifically, the code exemplarily provided in FIG. 7B specifies that when the first segment or flight is a domestic flight, the D/I indicator will indicate a value of ‘D’, and when the second segment or flight is a domestic flight, the D/I indicator will indicate a value of ‘D’, and then the upper limit value may be set to specify 360 minutes. The code also specifies that when the first segment or flight is a domestic flight, the D/I indicator will indicate a value of ‘D’, and when the second segment or flight is an international flight, the D/I indicator will indicate a value of ‘I’, and then the upper limit value may be set to specify 480 minutes. The code also specifies that when the first segment or flight is an international flight, the D/I indicator will indicate a value of ‘I’, and when the second segment or flight is a domestic flight, the D/I indicator will indicate a value of ‘D’, and then the upper limit value may be set to specify 480 minutes. Lastly, the code specifies that when the first segment or flight is an international flight, the D/I indicator will indicate a value of ‘I’, and when the second segment or flight is also an international flight, the D/I indicator will indicate a value of ‘I’, and then the upper limit value may be set to specify 720 minutes.

In operation 505, exception rules may be built. According to exemplary aspects, exception rules may be generated to ensure that the connections are valid and to limit a number of combinations that are to be built. According to further aspects, the exception rules may be generated by a machine learning model via iterative processing of input data. Moreover, the exception rules may be updated periodically or in real-time to add new exception rules, adjust existing exception rules and delete outdated exception rules. In an example, exception rules may include, without limitation, (i) no double-back: all airports on an itinerary are unique, (ii) for codeshare connections, take only those with the same marketing carrier on all legs, (iii) delete interline connections in markets with 4 non-stop jet services per day, and (iv) take only one connection with the shortest dwell time among all combinations with the same key. The key may include, without limitation: (a) departure date of flight 1, (b) departure window (e.g., morning, afternoon or evening) of flight 1, (c) marketing carrier of flight 1 and flight 2 for online and code connections (this field may be skipped for interline connections), (d) operating carrier of flight 1, (e) operating carrier of flight 2, (f) origin airport of flight 1, (g) destination airport of flight 1, which is also the origin airport of flight 2, and (h) destination airport of flight 2.

In operation 506, double connections may be built. According to exemplary aspects, double connections may be built by joining single connection results, which may include one-stops, online single connections, codeshare single connections and interline single connections, with itself. The condition may specify that the second leg of the first single connection overlaps with the first leg of the second single connection. More example, IAD-ORD-PEK may join with ORD-PEK-XIY to result in IAD-ORD-PEK-XIY.

There are at least two advantages to the above noted design. For one, the above described design has better performance. First, with such a design, the double connection building process runs faster than the single connection process, even though more records may be created in the double connection table. In other words, greater number of records may be processed in a shorter period of time for providing of technological advantage. Second, the above noted design allows the code to be generated in a cleaner manner. At least since the connection conditions (e.g., minimum connecting time, maximum connecting time, circuitry, LCC restriction and the like) have already been verified during the single connection process, those validations need not be replicated during the double connection building process. Steps to ensure that the double connection origins and destinations satisfy the circuitry threshold, cabotage rule and no domestic origin and destination with an international leg.

Additionally, one or more following rules may be applied to reduce the number of double connections built: (i) no double connections are built for markets within a predetermined number of miles (e.g., 600 miles), (ii) no interline double connections are built in the US domestic markets or within the EU region, and (iii) no interline double connections may be allowed in markets with a predetermined number (e.g., 4) of non-stop jet services per day. According to exemplary aspects, the above noted rules may be added onto, adjusted or removed with respect to time based on a manual input or an output by a machine learning model.

Further, although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of predicting demand at an airline level for a future flight path for procurement of an appropriate number and type of an aircraft, the method comprising:
acquiring and aggregating raw data, over a communication network and from one or more servers;
parsing, via a processor, the acquired raw data and identifying and aggregating a plurality of segments of location pairs;
building, via a computer model executed by the processor, a plurality of connections based on the aggregated plurality of segments of location pairs, wherein each of the plurality of segments of location pairs is serviced by an aircraft of at least one of a plurality of airlines;
for each of the plurality of segments of location pairs, generating, via the processor, a quality of service index (QSI) coefficient for each of the plurality of airlines;
determining, via the computer model executed by the processor, a connection window for one or more connection flights based on the aggregated plurality of segments of location pairs;
generating, via the processor and for each of the plurality of segments of location pairs, a circuitry curve based on a distance of a segment of a location pair;
determining, via the processor, flight share information at an airline level for a target segment of location pair based on a corresponding QSI coefficient and a corresponding circuitry curve;
determining, via the processor, agency gap values at the airline level for the target segment of location pair based on the flight share information; and
updating the computer model, via the processor, based on the flight share information and the agency gap values for predicting at least one of a number of seats expected for the target segment of location pair for a target airline and a corresponding aircraft type for the target segment of location pair.

2. The method according to claim 1, further comprising:
transmitting, to a computer of the target airline, at least one of the number of seats expected for the target segment of location pair and the corresponding type of aircraft for the target segment of location pair; and
assigning, by the computer of the target airline, the corresponding type of aircraft for the target segment of location pair.

3. The method according to claim 1, wherein the building of the plurality of connections includes:
applying, via the processor, one or more limits of air service restrictions;
reconstructing, via the processor, one-stop connections using the parsed raw data;
applying, via the processor, a minimum connect time for the reconstructed one-stop connections;
applying, via the processor, a maximum connect time for the reconstructed one-stop connections;
building, via the processor, one or more exception rules for the reconstructed one-stop connections; and
building, via the processor, double-stop connections.

4. The method according to claim 3, wherein the minimum connect time is determined by:
performing a matching operation between two or more values of an inbound airline, an outbound airline, a domestic or international indicator, and an interline or online indicator; and
selecting a minimum connect time associated with a matching record.

5. The method according to claim 3, wherein the maximum connect time is determined based on a combination of the domestic or international indicator for each segment of location pair included in the one-stop connections.

6. The method according to claim 5, wherein the maximum connect time is further determined based on the interline or online indicator for each segment of location pair included in the one-stop connections.

7. The method according to claim 1, wherein the generating of the QSI coefficient includes:
applying one or more QSI factor values based on a type of flight and an aircraft type.

8. The method according to claim 7, wherein the type of flight includes at least one of a non-stop flight and an one-stop flight.

9. The method according to claim 7, wherein the aircraft type includes at least one of a wide-body jet, a medium-body jet, a narrow-body jet, a regional jet, and a turboprop.

10. The method according to claim 7, wherein different coefficient values are used for different seat numbers for all non-stop flights.

11. The method according to claim 7, wherein a slope and intercept values of a circuitry curve corresponding to non-stop flights are utilized to calculate a QSI factor value for the aircraft type.

12. The method according to claim 9, wherein each of the wide-body jet, the medium-body jet, the narrow-body jet, the regional jet, and the turboprop aircraft types has different seat capacity.

13. The method according to claim 1, wherein the connection window includes at least one minimum connect time and at least one maximum connect time, and a corresponding QSI factor penalty for a connect time outside of the connection window.

14. The method according to claim 13, wherein different QSI factor penalty values are applied based on a total dwell time between connecting segments of location pairs.

15. The method according to claim 1, wherein each of the plurality of circuitry curves is based on a distance between each segment of location pair.

16. The method according to claim 1, wherein the flight share information at the airline level is determined by:
for each segment of location pair of the plurality of segments of location pairs, multiply a service count by an airline with a corresponding QSI factor value.

17. The method according to claim 1, wherein the flight share information at the airline level is determined by:
for each segment of location pair of the plurality of segments of location pairs serviced by an airline, divide a QSI factor for the respective segment of location pair and divide by a sum of QSI factors of all of the plurality of airlines.

18. The method according to claim 1, wherein the agency gap values at the airline level is determined by determining an agency share per airline for a segment of location pair and determining a difference between the agency share and the market share information.

19. A system for predicting demand at an airline level for a future flight path for procurement of an appropriate number and type of an aircraft, the system comprising:
a memory;
a display; and
a processor,
wherein the system is configured to perform:
acquiring and aggregating raw data, over a communication network and from one or more servers;
parsing the acquired raw data and identifying and aggregating a plurality of segments of location pairs;
building, via a computer model, a plurality of connections based on the aggregated plurality of segments of location pairs, wherein each of the plurality of segments of location pairs is serviced by an aircraft of at least one of a plurality of airlines;
for each of the plurality of segments of location pairs, generating a quality of service index (QSI) coefficient for each of the plurality of airlines;
determining, via the computer model, a connection window for one or more connection flights based on the aggregated plurality of segments of location pairs;
generating, for each of the plurality of segments of location pairs, a circuitry curve based on a distance of a segment of a location pair;
determining flight share information at an airline level for a target segment of location pair based on a corresponding QSI coefficient and a corresponding circuitry curve;
determining agency gap values at the airline level for the target segment of location pair based on the flight share information; and
updating the computer model based on the flight share information and the agency gap values for predicting at least one of a number of seats expected for the target segment of location pair for a target airline and a corresponding aircraft type for the target segment of location pair.

20. A non-transitory computer readable storage medium that stores a computer program for predicting demand at an airline level for a future flight path for procurement of an appropriate number and type of an aircraft, the computer program, when executed by a processor, causing a system to perform a plurality of processes comprising:
acquiring and aggregating raw data, over a communication network and from one or more servers;
parsing the acquired raw data and identifying and aggregating a plurality of segments of location pairs;
building, via a computer model, a plurality of connections based on the aggregated plurality of segments of location pairs, wherein each of the plurality of segments of location pairs is serviced by an aircraft of at least one of a plurality of airlines;
for each of the plurality of segments of location pairs, generating a quality of service index (QSI) coefficient for each of the plurality of airlines;
determining, via the computer model, a connection window for one or more connection flights based on the aggregated plurality of segments of location pairs;
generating, for each of the plurality of segments of location pairs, a circuitry curve based on a distance of a segment of a location pair;
determining flight share information at an airline level for a target segment of location pair based on a corresponding QSI coefficient and a corresponding circuitry curve;
determining agency gap values at the airline level for the target segment of location pair based on the flight share information; and
updating the computer model based on the flight share information and the agency gap values for predicting at least one of a number of seats expected for the target segment of location pair for a target airline and a corresponding aircraft type for the target segment of location pair.
